(19) United States
(12) Patent Application Publication
(10) Pub. No.: US 2011/0299056 A1
(43) Pub. Date: Dec. 8, 2011

(54) System and Method Configured to Provide Predetermined Depth Of Focus and to Control Irradiance Distribution

(75) Inventors: David M. Williamson, Tucson, AZ (US); Daniel G. Smith, Tucson, AZ (US)

(73) Assignee: Nikon Corporation, Tokyo (JP)

(21) Appl. No.: 12/796,490

(22) Filed: Jun. 8, 2010

(51) Int. Cl. G03B 27/72

(52) U.S. Cl. 355/71; 355/77

(57) ABSTRACT

A system and method for illuminating an imaging optical system are provided, designed to spread the irradiance distribution at a pupil located at a mirror, to decrease the maximum irradiance on the mirror in the pupil, while maintaining a predetermined depth of focus of the imaging optical system (i.e. a depth of focus that is predetermined to be acceptable for the particular imaging optical application).

### BACKGROUND

The present invention relates to illumination of an imaging optical system, in which radiation is projected from a reticle to an image plane, in a manner that maintains a predetermined depth of focus of the imaging optical system while decreasing the maximum irradiance on a mirror located in the pupil of the imaging optical system.

In an imaging optical system, particularly a lithographic imaging optical system, it is often desirable to project radiation (e.g. coherent laser radiation) from a reticle to an image plane, where the radiation that illuminates the reticle is reflected from a mirror located at a pupil of the imaging optical system. Such a system may be used, e.g. projecting an image to an array of semiconductor wafer dies located on a substrate and/or to one or more partial dies at the boundary of the substrate.

In such a system, it is desirable to produce the best depth of focus possible. However, when radiation is reflected from a mirror located at a pupil of the system, applicants believe it is desirable to address the issue of one or more “hot spots”, or regions of high irradiance, that can be created on the mirror's reflective coating maximum irradiation is directed at relatively small “spots” on the mirror coating. If such spots wear out the mirror coating, or damage the mirror, more frequently than anticipated, they may require replacement or repair of the mirror, with a frequency that is not desirable where the “cost” of the production of the semi conductor chips is an important criterion.

### SUMMARY OF THE INVENTION

The present invention provides a new and useful system and method for illuminating the reticle of an optical imaging system, designed to reduce potential damage to a mirror or mirror coating, while maintaining a predetermined depth of focus in the optical imaging system. The illumination system and method are designed to spread the irradiance distribution in the pupil which is conjugate to a mirror, to decrease the maximum irradiance on the mirror in the pupil, while maintaining a predetermined depth of focus of the system (i.e. a depth of focus that is predetermined to be acceptable for the particular imaging optical application).

More specifically, the present invention provides a way of illuminating an imaging optical system, in a way that maintains a predetermined depth of focus at the image plane, while controlling the maximum irradiance directed at a mirror located at a pupil (by spreading the irradiance distribution the mirror in the pupil). The illumination system and method of the invention is designed to control the maximum irradiance at a mirror located at a pupil by illuminating the reticle at a plurality of angles and spreading the irradiance distribution in one or more predetermined directions in the pupil and at the mirror.

In a preferred version of the present invention, illumination of the reticle produces lines that are projected in one or more predetermined directions by the imaging optical system, and the illumination concept of the present invention is configured to spread the irradiance distribution at the pupil in at least one of the predetermined directions of the lines produced by the illumination of the reticle.

Other features of the present invention will become further apparent from the following detailed description and the accompanying drawings.

### BRIEF DESCRIPTION OF THE DRAWINGS

FIG. 1 is a schematic illustration of a way of illuminating the reticle of an imaging optical system, to provide a predetermined depth of focus, while minimizing maximum irradiance at the system pupil, according to the principles of the system and method of the present invention;

FIGS. 1a through 1d are schematic enlarged views of the irradiance distribution at certain components of the system, in a system and method according to the principles of the present invention; and

FIG. 1e is a schematic, enlarged view of the image plane, in a system and method according to the principles of the present invention.

### DETAILED DESCRIPTION

As discussed above, the present invention relates to a new and useful illumination system and method designed to maintain a predetermined depth of focus in an optical imaging system, while controlling the maximum irradiance at the system pupil. The principles of the present invention are described below in connection with a lithographic optical imaging system and method, and from that description the manner in which the illumination principles of the present invention can be used with various types of optical imaging systems will be apparent to those in the art.

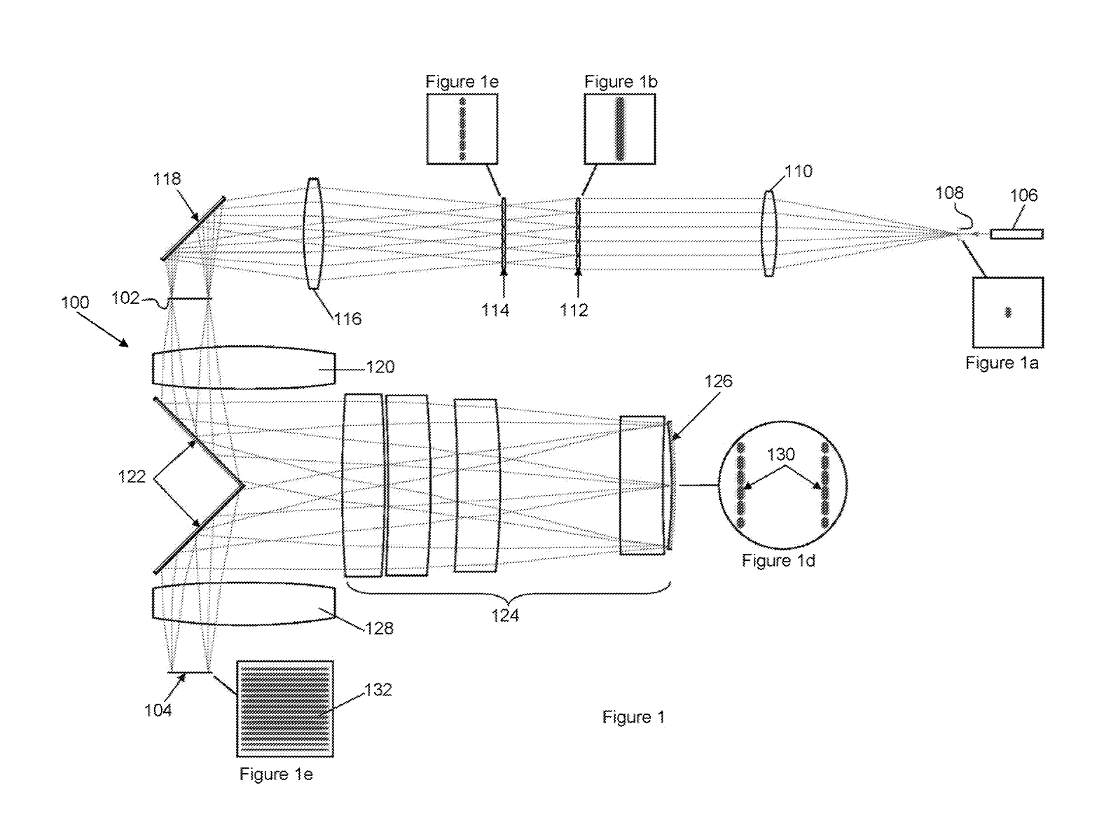

FIGS. 1, and 1a-1e schematically illustrate an imaging optical system 100 and a way of illuminating a reticle of the imaging optical system that applies the principles of the present invention. The imaging optical system 100 is designed to transmit an image from a reticle 102 to an image plane 104. The image originates from a source 106 that can be, e.g. a laser that generates coherent light (radiation) in a 193 nm wavelength. In a lithographic imaging system, of the type that would image (i.e. print line/space patterns on) a plurality of wafer dies supported on a substrate, there may be incomplete dies at the perimeter of the substrate, and it is desirable to transmit images (i.e. line/space patterns) to those incomplete dies, where the images that are transmitted do not have to be the same as the images produced in the full dies, but can be images of a simplified reticle that are used to expose partial nonfunctioning dies sometimes referred to as “edge shots”. The principles of the present invention are particularly applicable to such an imaging optical system and method. Moreover, the illumination principles of the invention can be used in connection with the printing line/space patterns on the array of wafer dies, as well as the edge shots.

The illumination concept of the present invention illuminates the reticle 102 of the imaging optical system. According to the illumination concept of the present invention, coherent radiation from the source 106 is directed though a diffractive optical element (DOE) 108 that has an irradiance distribution shown in FIG. 1a, and diffracts the radiation that is directed though a lens 110. The lens 110 is preferably a fourier transform lens that produces a fourier transform of the diffracted radiation produced by the DOE. The transformed radiation from the lens 110 is directed to a first lenslet array 112 which comprises an array of lenslets commonly referred to as the first “fly's eye”. The irradiance distribution of the radiation that is directed to the first lenslet array 112 is shown in FIG. 1b. Essentially, that irradiance distribution at the first lenslet array 112 looks like a single image in a predetermined direction. The radiation from the first lenslet array 112 is focused at a second lenslet array 114 (commonly referred to as the second “fly's eye”), which together with lens 116 (commonly referred to as the condenser lens) produces overlapping images of the lenslets of the first array 112. FIG. 1c shows the irradiance distribution produced on the second lenslet array 114. As seen from FIG. 1c, the irradiance distribution on the second lenslet array 114 appears as a closely spaced series of source images, oriented in a predetermined direction. The radiation from the second lenslet array is directed through a condenser lens 116, reflected by a mirror 118, and illuminates the reticle 102 at a plurality of angles. The reticle 102 can be one of several known types, e.g. phase shifting, sinusoidal grating, etc. that produces the desired image in the form of a series of lines (e.g. the lines that are shown as imaged to the image plane in FIG. 1e).

It will be clear to those in the art that while a few lenslets are shown in each of the first and second lenslet arrays 112, 114, in practice there may be many more lenslets in each of the first and second lenslet arrays, thereby improving the uniformity of irradiance at the reticle plane 102.

From the reticle 102, the image is reflected by one side of a V-shaped mirror 122, and transmitted by a series of optics 124 (i.e. a series of lens elements) to a concave mirror 126 located at a pupil of the imaging optical system. The concave mirror 126 reflects the image back through the series of optics 124 and at the other side of the V-shaped mirror 122. The image is then transmitted though an optic 128 and to the image plane 104.

In accordance with the principles of the present invention, the illumination system spreads the irradiance distribution at the pupil which is conjugate to the concave mirror 126, in a manner that maintains a predetermined depth of focus while spreading the irradiance distribution at the mirror pupil to reduce the maximum irradiance on the mirror at the pupil. As shown in FIG. 1d, the system is designed to spread the irradiance distribution at the pupil in predetermined direction(s) 130. More specifically, by producing the overlapping images from the first and second lenslet arrays, 112, 114, and directing those overlapping images so they are incident on the reticle from a plurality of directions (i.e. at a plurality of angles), the irradiance distribution at the mirror pupil is spread in predetermined direction(s) 130. Illuminating the reticle at the plurality of angles avoids light being concentrated at one angle (which would correspond to a point of high irradiance in the pupil of the imaging optical system), and spreads the irradiance distribution in the manner described herein.

The predetermined direction in which the irradiance is spread is preferably in the direction of the lines that are produced at the image plane 104. Thus, the direction 130 in which irradiance is spread at the system pupil, when transmitted to the image plane 104, in the manner described above, would be the same direction as the lines 132 that are produced at the image plane 104.

By spreading the irradiance distribution at the system pupil, in the manner described above, the illumination system and method of the present invention reduces maximum irradiance from being directed to a single area (known as a “hot spot”) of the mirror, and thereby minimizes the likelihood of damage to the mirror or to a coating on the mirror surface at that hot spot. In addition, the use of coherent radiation as the source, and the transmission of the radiation from the reticle to the image plane in the manner described herein, produces a predetermined depth of focus of the image at the image plane 104 (in the sense that the depth of focus will be at a predetermined level that is acceptable for the particular application)

Thus, the illumination of the reticle 102 of the imaging optical system 100, in the manner described herein, is designed to project radiation along an imaging optical path from the reticle 102 to the image plane 104, in a manner that maintains a predetermined depth of focus of the imaging optical system while controlling the maximum irradiance directed at the mirror 126 located at a pupil in the imaging optical path. The imaging optical system is configured to project radiation along the imaging optical path in a manner that illuminates the reticle 102 at a plurality of angles and spreads the irradiance distribution in one or more predetermined directions 130 at the pupil. In the illustrated embodiment, the imaging optical system is configured to spread the irradiance distribution at the pupil in at least one of the predetermined directions of the lines produced by the illumination of the reticle.

Thus, the present invention provides an illumination system and method designed to maintain a predetermined depth of focus in an optical imaging system in which radiation is projected from a reticle to an image plane, while spreading the irradiance distribution at a system pupil located at a mirror. With the present invention, radiation is effectively spread out at the pupil, to decrease the maximum irradiance on the mirror in the pupil while maintaining a predetermined depth of focus (i.e. a depth of focus that is predetermined to be acceptable for the particular imaging optical application).

With the foregoing disclosure in mind, it is believed that various ways of illuminating an imaging optical system, to maintain a predetermined depth of focus while spreading irradiance at a system pupil, according to the principles of the present invention, will be apparent to those in the art.

1. An illumination system that provides illumination to an imaging optical system configured to project radiation along an imaging optical path from a reticle to an image plane, to maintain a predetermined depth of focus of the imaging optical system while controlling the maximum irradiance directed at a mirror located at a pupil in the imaging optical path, the illumination system configured to illuminate the reticle at a plurality of angles and to spread the irradiance distribution in one or more predetermined directions at the pupil.

2. An illumination system as defined in claim 1, wherein the imaging optical system is configured such that illumination of the reticle produces lines that are projected in one or more predetermined directions at the image plane, and wherein the illumination system is configured to spread the irradiance distribution at the pupil in at least one of the predetermined directions of the lines produced by the illumination of the reticle.

3. A method for illuminating an imaging optical system that projects radiation along an imaging optical path from a reticle to an image plane, to maintain a predetermined depth of focus of the imaging optical system while controlling the maximum irradiance directed at a mirror located at a pupil in the imaging optical path, comprising projecting radiation in a manner that illuminates the reticle at a plurality of angles and spreads the irradiance distribution in one or more predetermined directions at the pupil.

4. A method as defined in claim 3, wherein illumination of the reticle produces lines that are projected in one or more predetermined directions by the imaging optical system, and the step of illuminating the reticle at a plurality of angles spreads the irradiance distribution at the pupil in at least one of the predetermined directions of the lines projected by the imaging optical system.
